(19) United States
(12) Patent Application Publication
(10) Pub. No.: US 2012/0318108 A1
(43) Pub. Date: Dec. 20, 2012

(54) DRIVING ELEMENT, TRANSPORTING DEVICE, AND FASTENER DRIVING TOOL

(75) Inventors: Markus KIEBER, Schaanwald (LI); Marco ZURKIRCHEN, Bubikon (CH)

(73) Assignee: Hilti Aktiengesellschaft, Schaan (LI)

(21) Appl. No.: 13/493,243

(22) Filed: Jun. 11, 2012

(30) Foreign Application Priority Data
Jun. 10, 2011 (DE) 102011077433.5

(51) Int. Cl. B25B 23/04; B25B 23/08

(52) U.S. Cl. 81/434; 81/57.37

(57) ABSTRACT

A tool to drive fastening elements into a substrate, with a prefastening position for a fastening element, with a driving element that drives a fastening element in the prefastening position in a fastening direction into the substrate, with a transporting element, which can he meshed with a fastening element or a strip embracing a fastening element, so as to transport the fastening element in a transporting direction into the prefastening position, wherein the driving element has a fastening element that actuates the transporting element for the transporting of the fastening element into the prefastening position, is provided.

### CROSS-REFERENCE TO RELATED APPLICATIONS

This patent application claims the benefit of German Patent Application No. DE 102011077433.5, filed Jun. 10, 2011, which is incorporated by reference.

### BACKGROUND OF THE INVENTION

The invention concerns a driving element to drive a fastening element from a prefastening position, in a fastening direction into a substrate, in particular, for a fastener driving tool. Furthermore, the invention concerns a transporting device to transport fastening elements in a transporting direction into a prefastening position, and a tool to drive fastening elements into a substrate.

Such tools are usually used to drive fastening elements into a substrate. DE 42 19 095 C1, for example describes a driving tool and a feed device for the driving tool. If the driving tool is pressed on a substrate, the feed device transports a fastening element into a recess from which the fastening means is driven, by a screwdriver, into the substrate. To this end, the user of the driving tool must apply an additional force when he presses the driving tool against the substrate.

### BRIEF SUMMARY OF THE INVENTION

One objective of the invention is to make available a driving element, a transporting device, and a fastener driving tool that enable slight pressing force against a substrate.

With a driving element to drive a fastening element from a prefastening position in a fastening direction into a substrate, this objective is achieved in that the driving element has an actuation element which is suitable for actuating a transport of the fastening element into the prefastening position of a transporting device. In this way, a part of the driving energy that is transferred from the driving element to the fastening element can be used for the transporting of the fastening element.

In accordance with a preferred embodiment, the driving element comprises a rotary drive, which can be meshed with a rotary drive of a fastener driving tool for the transfer of a torque. In accordance with a preferred embodiment, the driving element comprises a screw drive to drive the fastening element.

In accordance with a preferred embodiment, the actuation element is designed as a projection on the circumference of the driving element. With particular preference, the projection stands out from the driving element, perpendicular to the fastening direction. The projection is preferably formed circumferentially.

In accordance with a preferred embodiment, the actuation element has a ramp relative to the circumference of the driving element. With particular preference, the actuation element, viewed in the fastening direction, is designed with an oval shape. In accordance with a likewise preferred alternative, the actuation element is designed with an elliptical shape.

With a transporting device to transport fastening elements in a transporting direction into a prefastening position, having a passage for a driving element of the fastener driving tool, wherein the passage extends in the fastening direction and comprises the prefastening position, the objective is achieved in that the transporting device comprises a releasing element that can be meshed with an actuation element of the driving element that moves through the passage, in order to release the transporting of a fastening element into the prefastening position by the transporting device. In this way, at least a part of the energy that is needed for the transporting of the actuation element can be accessed by the driving element or, via the driving element, by the fastening driving tool that drives the driving element.

In accordance with a preferred embodiment, the transporting device comprises an energy storage unit, which pre-stresses the release element against an actuation by the actuation element. Preferably, the energy storage unit comprises a spring element, which, with particular preference, is designed as a coil spring.

In accordance with a preferred embodiment, the transporting device has a transporting element, Which can be meshed with the fastening element or a strip embracing the fastening element, so as to transport the fastening element in the transporting direction into the prefastening position.

In accordance with a preferred embodiment, the transporting element is deflected by the actuation element upon actuation of the transporting device. With particular preference, the force of the energy storage unit acts against this deflection. In accordance with a preferred embodiment, the transporting element carries out a feed movement contrary to the deflection, after the end of the actuation by the actuation element so as to transport the fastening element into the prefastening position. With particular preference, the feed movement is brought about or supported by the force of the energy storage unit.

In accordance with a preferred embodiment, the transporting element has an entrainer to transport the fastening element. With particular preference, the entrainer is spring-loaded by means of a spring drive against the fastening element or a strip embracing the fastening element.

In accordance with a preferred embodiment, the transporting element is designed as a transport slide. With particular preference, the transport slide can move linearly.

In accordance with a preferred embodiment, the transporting element has one or more transporting teeth to mesh into corresponding recesses on a strip embracing the fastening element.

In accordance with a preferred embodiment, the driving element or the transporting device is integrated into a tool to drive fastening elements into a substrate. The tool preferably comprises a rotary drive for the driving element.

In accordance with a preferred embodiment, the actuation element is suitable for actuating the transporting device during a driving operation. With particular preference, the actuation element is suitable for actuating the transporting device at the end of the driving operation. The actuation element is preferably located staggered relative to the release element, in a starting position of the driving element, against the fastening direction. During the driving operation, the driving element is moved in the driving direction, so that the actuation element is meshed with the transporting device at a desired time so as to actuate it.

### BRIEF DESCRIPTION OF THE SEVERAL VIEWS OF THE DRAWING(S)

Other features and advantages can be deduced from the embodiment examples and from the dependent claims. Preferred embodiment examples are explained, in more detail, with reference to the attached drawings. The figures show the following:

FIG. 1, a fastener driving tool in a side view;

FIG. 2, a driving element and a transporting device in a side view;

FIG. 3, a driving element and a transporting device in a view in the fastening direction; and

FIG. 4, a driving element and a transporting device in an inclined view.

### DETAILED DESCRIPTION OF THE INVENTION

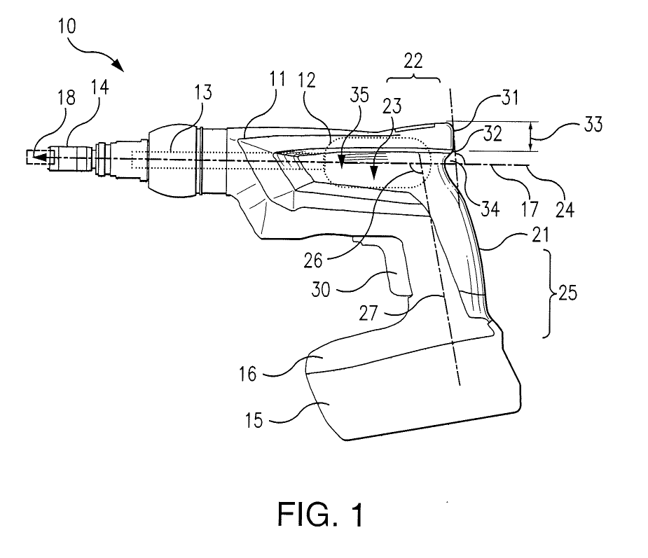

FIG. 1 shows an electric screwdriver 10 as an example of a fastener driving tool in a side view. The electric screwdriver 10 has an angled housing 11, in which a motor 12 is coupled with a rotary drive 14 having a drive train 13. The drive train 13 comprises, for example, at least one spindle, one gear, an overload coupling, and/or a tangential impact mechanism. Energy is provided to the electric screwdriver 10, the motor 12 in particular, by means of an accumulator 15, which is affixed detachably on a foot 16 of the housing 11.

The rotary drive 14 fixes a driving direction 17 of the electric screwdriver 10, in that it aligns a driving element 18 along the driving direction 17. A user of the electric screwdriver 10 exerts a pressing pressure in the driving direction 17, so as to drive a fastening element, rotating, into a workpiece.

The user can place a guiding hand on a back side 21 of the housing 11, turned away from the rotary drive 14. The thumb and index finger lie laterally on the housing 11 on either side of the symmetry plane 20, in a contact area 22. The contact area 22 begins on the back side 21 of the housing 11 and has two legs 23 in a U shape that run in the direction of the rotary drive 14 and enclose the housing 11 between them.

Inclined toward the working axis 17, the angled housing 11 has a shaft 25. The shaft 25 forms a handle 28 together with the contact area 22. The guiding hand can grasp the shaft with the remaining fingers. An operating button 30 is provided on the front side 29 of the shaft 25 pointing to the rotary drive 14; it is used to activate the electric screwdriver 10, in particular, the motor 12. A recessed grip 34 and a contact area 31 for a second hand are provided on the back side 21 of the housing 11. The contact area 31 is located on the side of the guide plane 24, opposite the shaft 25, and, more or less, as a prolongation of the shaft 25.

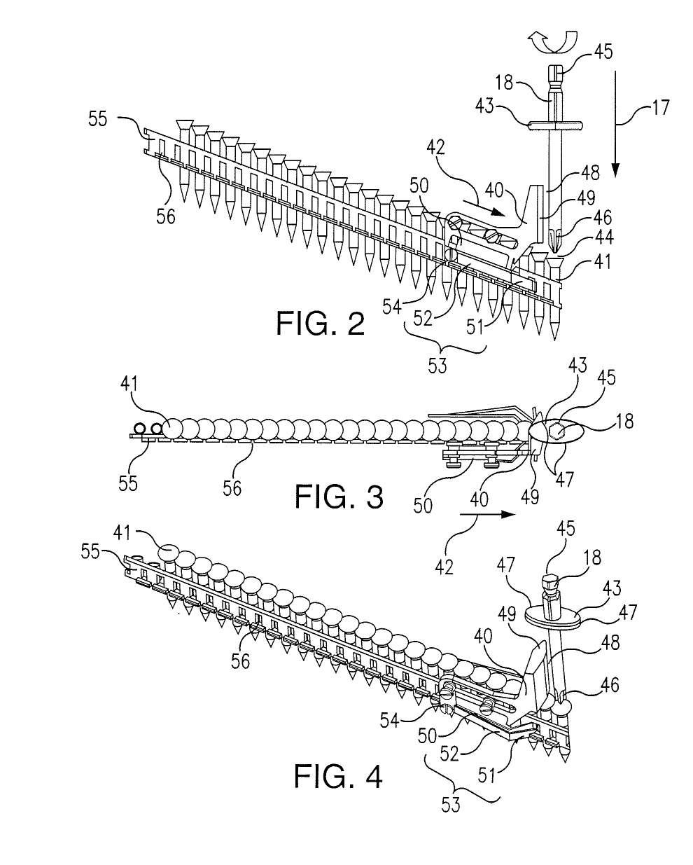

FIGS. 2 to 4 show the driving element 18 and a transporting device 40 to transport fastening elements 41 in a transporting direction 42 before the driving element 18. The driving element 18 comprises a rotary drive 45, which can be meshed with the rotary drive 14 of the fastener driving tool 1 for torque transfer, and a screw drive 46 for rotatably driving the fastening elements 41.

The driving element 18 has an actuation element 43 which is used to actuate the transporting device 40 so as to transport one of the fastening elements 41 into a prefastening position (or intermediate position) 44 in the transporting device 40. The actuation element 43 is designed as a surrounding, elliptical projection on a circumference of the driving element 18 and thus has, relative to the circumference of the driving element 18, two ramps 47. The actuation element 43 thereby projects from the driving element 18, perpendicular to the fastening direction 17.

The transporting device has a preferred channel-shaped space 48 for the driving element 18 of the fastener driving tool 1, wherein the space 48 extends in the fastening direction 17 and comprises the prefastening position 44. The transporting device 40 comprises a release element 49, which is meshed with the actuation element 43 of the driving element 18 when the driving element 18 is moved through the space 48 in the driving direction 17, so as to release the transporting of a fastening element 41 into the prefastening position 44, through the transporting device 40. A transporting element 53, designed as a transporting slider 42 that can move linearly along the transporting direction 42 is fastened on the release element 49 by means of a screw 54 and comprises an entrainer 51, which can be meshed with recesses 56 of the strip 55, and a spring drive 52, which pre-stresses the entrainer on the strip 55 with the fastening elements 41.

Upon actuation by the actuation element 43, the release element 49, in FIGS. 2 to 4, is deflected to the left against the force of a spring element 50, which pre-stresses the release element 49 against the actuation by the actuation element 43 and thus acts against the deflection. The force required for this is applied through the fastener driving tool 1 by means of the driving element 18, thus providing relief to the user of the fastener driving tool 1. The entrainer is thereby moved to the next recess 56 of the strip 55 and engages there by means of the spring drive 52. After ending the actuation by the actuation element 43, the release element 49 carries out a feed movement, contrary to the deflection, so as to transport the fastening element into the prefastening position, in that the spring element 50 moves the release element 49, the transporting element 53, and the strip 55 with the fastening elements 41 to the right in FIGS. 2 to 4. In an embodiment example that is not depicted, the transporting element has one or more transporting teeth to mesh into the recesses 56, Using FIGS. 2-4 for reference, the strip 55 can be on the other side of the fastening elements such that the transporting element engages between fastening elements, so as to transport the fastening element in a transporting direction in the prefastening position.

In a starting position of the driving element 18, the actuation element 43 is located staggered, relative to the release element 49, against the fastening direction 17. During the driving operation, the driving element 18, and thus the actuation element 43, are moved in the driving direction 17, toward the release element 49, so that the actuation element 43 meshes with the release element 49 of the transporting device 40 toward the end of the driving operation by rotation via one of the ramps 47, so as to actuate the transporting device 40.

The invention under consideration was described with the aid of the example of an electric screwdriver. It should be pointed out, however, that the invention is also suitable for other applications.

1. A driving element for driving a driver tool fastening element from a prefastening position in a fastening direction into a substrate comprising an actuation element suitable for actuating a transporting device to transport the fastening element into the prefastening position.

2. The driving element according to claim 1, wherein the actuation element comprises a surrounding projection on a circumference of the driving element.

3. The driving element according to claim 1, wherein the actuation element has a ramp, relative to the circumference of the driving element.

4. The driving element according to claim 1, wherein the actuation element, when viewed in the fastening direction, is oval or elliptical.

5. A transporting device for transporting driver tool fastening elements in a transporting direction into a prefastening position, with a passage for a driving element of the fastener driving tool, wherein the passage extends in a fastening direction and comprises the prefastening position, comprising release element that meshes with an actuation element of the driving element moving through the passage, so as to release the transport of the fastening element into the prefastening position.

6. The transporting device according to claim 5, comprising an energy storage unit which pre-stresses the release element against an actuation by the actuation element.

7. The transporting device according to claim 5, wherein the transporting device has a transporting element that meshes with the fastening element or a strip embracing the fastening element, so as to transport the fastening element in the transporting device into the prefastening position.

8. The transporting device according to claim 5, wherein upon actuation of the transporting device by the actuation element, the transporting unit is deflected and after the end of the actuation by the actuation element a feed movement opposite to the deflection is carried out so as to transport the fastening element into the prefastening position.

9. The transporting device according to claim 5, wherein the transporting element has an entrainer to transport the fastening element, which is spring-loaded by a spring drive.

10. The transporting device according to claim 5, wherein the transporting element is a linearly movable transporting slide.

11. The transporting device according to claim 5, wherein the transporting element has one or more transporting teeth to mesh into corresponding recesses on a strip embracing the fastening element.

12. A tool for driving fastening elements from a prefastening position in a fastening direction into a substrate, comprising a driving element comprising an actuation element suitable for actuating a transporting device to transport a fastening clement into the prefastening position and a transporting device in accordance with claim 5.

13. The tool according to claim 12, comprising a rotary drive for the driving element, wherein the driving element comprises a screw drive.

14. The tool according to claim 12, wherein the actuation element is suitable for actuating the transporting device during a driving operation.

15. The tool according to claim 12, wherein the actuation element is located staggered, relative to the release element, in a starting position of the driving element, in the fastening direction.

16. The driving element according to claim 2, wherein the actuation element has a ramp, relative to the circumference of the driving element.

17. The driving element according to claim 2, wherein the actuation element, when viewed in the fastening direction, is oval or elliptical.

18. The driving element according to claim 3, wherein the actuation element, when viewed in the fastening direction, is oval or elliptical.

19. The transporting device according to claim 6, wherein the energy storage unit comprises a spring element.

20. The transporting device according to claim 6, wherein the transporting device has a transporting element that meshes with the fastening element or a strip embracing the fastening element, so as to transport the fastening element in the transporting device into the prefastening position.
